(19) United States
(12) Patent Application Publication
(10) Pub. No.: US 2026/0243706 A1
(43) Pub. Date: Aug. 20, 2026

(54) ARTICLE INSPECTION APPARATUS AND ARTICLE INSPECTION SYSTEM

(71) Applicant: ANRITSU CORPORATION, Kanagawa (JP)

(72) Inventors: Takeshi YAMAZAKI, Kanagawa (JP); Hiroki WATANABE, Kanagawa (JP)

(21) Appl. No.: 19/533,406

(22) Filed: Feb. 9, 2026

(30) Foreign Application Priority Data
Feb. 19, 2025 (JP) 2025-024686

(51) Int. Cl. G01N 23/04; G01N 23/083

(52) U.S. Cl. CPC G01N 23/04; G01N 23/083; G01N 2223/401; G01N 2223/643

(57) ABSTRACT

An article inspection apparatus includes a sensor that outputs a detection signal for inspecting an article, an inspection unit that applies a trained model to the detection signal to inspect the article, a communication interface, model information storage means for storing identification information of the trained model, trained model acquisition means for transmitting the identification information of the trained model specified by software update waiting information related to an addition or update of the trained model to an external server and acquiring the trained model and the identification information, and an identification information management unit that, in a case where the acquired trained model is installed in the inspection unit, additionally stores the identification information of the trained model in the model information storage means.

### TECHNICAL FIELD

The present invention relates to an article inspection apparatus and an article inspection system, and particularly to an article inspection apparatus and an article inspection system that inspect a quality state of an article as an inspection target by applying a trained model to an inspection image or a sensor signal according to the quality state of the article as the inspection target, and also relates to a software management method of managing a software update related to an addition or update of the trained model.

### BACKGROUND ART

In the related art, an article inspection apparatus that detects a quality state of an inspection object, for example, defect detection of mixed foreign matter, missing products, defective seals of packaging packages, and the like, or performs volume measurement or relative mass measurement, based on an inspection image obtained by imaging the inspection object during transport with X-rays, near infrared rays, or the like, and an article inspection system including the article inspection apparatus are known.

In such an article inspection apparatus and an article inspection system, recently, a machine-trained model, that is, a so-called artificial intelligence (AI) trained model is applied to an inspection image or a sensor signal including a feature amount corresponding to a quality state of an article to inspect the quality state of the article.

For example, in order to improve article inspection accuracy, there is a technique in which a plurality of images with different input systems are captured under an imaging condition according to each input system to acquire image data in which the plurality of images of an inspection object are set, and to store the image data in an image storage unit, and in advance, a trained model for inspection determination, which is trained with machine learning using training image data acquired under the same imaging condition as the image data of the inspection object stored in the image storage unit, is prepared, and the image data of the inspection object acquired during an actual inspection is processed for each pixel by the trained model to obtain a quality defect degree, and the quality defect degree is compared with a preset threshold value to determine a quality state of the inspection object (for example, see Patent Document 1).

In addition, there is a technique in which a pseudo image generation model capable of pseudo-generating X-ray image data in another energy band corresponding to X-ray image data in a predetermined energy band is created based on a training result of X-ray image data in a plurality of energy bands related to a training target item, a pseudo transmission image in another energy band is created by the pseudo image generation model based on X-ray image data of an inspection object acquired at a time of an actual inspection, and a quality state of an article is determined based on the X-ray image data in the predetermined energy band acquired at the time of the actual inspection and the pseudo transmission image in the other energy band created by the pseudo image generation model (for example, see Patent Document 2).

### Related art Document

### Patent Document

Patent Document 1 JP-A-2023-114828

Patent Document 2 JP-A-2021-148486

### Disclosure of the Invention

### Problem that the Invention is to Solve

In the article inspection apparatus and the article inspection system equipped with the trained model in the related art as described above, it may be required to update the trained model through additional training in the future according to a change of the inspection target article or the like. Meanwhile, depending on a content of the update, for example, even though a defective product that has been additionally trained can be detected, detection accuracy of the defective product that can be detected with high accuracy by the trained model before the additional training may be decreased.

Therefore, in a case where the additionally trained model is put into an actual production line where the article inspection apparatus is disposed, in order to evaluate performance of the additional trained model, it is necessary to flow a relatively large number of set values of the article of the inspection target variety by test production, and there is a concern that a loss of food or packaging material will be caused.

In view of such a problem, the applicant of the present application has proposed an article inspection apparatus that can reliably prevent a deterioration of yield due to erroneous detection at an update of a trained model in another application (see Japanese Patent Application No. 2024-007526).

Meanwhile, with the spread of the article inspection apparatus equipped with the trained model, it is considered that management of the trained model installed on the article inspection apparatus owned by a customer is complicated for both a manufacturer and the customer, and there is room for improvement in this regard.

Therefore, an object of the present invention is to provide an article inspection apparatus and an article inspection system capable of preventing management of a trained model from becoming complicated, and to realize a software management method of the article inspection apparatus capable of preventing the management of the trained model from becoming complicated.

### Means for solving the problem

According to a first embodiment, there is provided an article inspection apparatus including: a sensor that outputs a detection signal for inspecting a quality state of an article; an inspection unit that inspects the quality state of the article by applying a trained model to a predetermined detection signal output by the sensor during a movement of the article; a communication interface for communicating with an external server; model information storage means for storing identification information of the trained model installed in the article inspection apparatus; trained model acquisition means for receiving software update waiting information related to an addition or update of the trained model, transmitting the identification information of the trained model specified by the received information to the external server, and acquiring the trained model which is added or updated and the identification information of the trained model, via the communication interface; and an identification information management unit that, in a case where the trained model acquired by the trained model acquisition means is installed in the inspection unit for the addition or update, additionally stores the identification information of the installed trained model in the model information storage means.

With this configuration, the identification information of the trained model in use is stored in the model information storage means, and in a case where the software update waiting information is received, it is easy to determine whether or not the trained model specified by the received information is in use or is a software update target by the identification information, and in a case where the trained model is the software update target, the identification information of the trained model can be transmitted to the external server, and the trained model which is added or updated can be acquired by the trained model acquisition means by downloading or the like. Then, in a case where the acquired trained model is installed in the inspection unit for the addition or update, the identification information of the trained model is additionally stored in the model information storage means by the identification information management unit. Therefore, at the time of additional training of the trained model in use or at the time of function addition by a newly trained model, the information related to the trained model in use on a user side who owns the article inspection apparatus is accurately managed for each apparatus, and it is possible to prevent the management of the trained model from becoming complicated.

According to a second embodiment, the trained model acquisition means may be configured to transmit, in a case where the identification information of the trained model designated by the software update waiting information matches any of the identification information of the trained model stored in the model information storage means, identification information of the matching trained model to the external server together with an individual identification code of the article inspection apparatus.

In this manner, on the manufacturer side having the external server, it is possible to accurately grasp a software update state related to the addition or update of the trained model in use in each article inspection apparatus as a software update target based on the individual identification code of each apparatus, and to centrally manage information related to the software update.

According to a third embodiment and a fourth embodiment, the trained model acquisition means may include selection control means for acquiring the identification information of the trained model designated by the software update waiting information as at least one model identification code and displaying the model identification code on a screen, and selecting the identification information of the trained model to be transmitted to the external server, from the identification code being displayed on the screen according to a selection operation input.

In this case, a user of each article inspection apparatus can easily set whether or not a software update is necessary and an update time.

According to a fifth embodiment, there is provided an article inspection system including: the article inspection apparatus according to the first embodiment; and a file server as the external server that is provided to be connectable to the article inspection apparatus through a network, in which the file server has a database for managing the identification information of the trained model acquired by the article inspection apparatus at least in association with the article inspection apparatus.

With this configuration, since the identification information of the trained model acquired by each article inspection apparatus is managed in the database at least in association with the article inspection apparatus, a manufacturer side having the external server can accurately grasp a software update state related to the addition or update of the trained model in use in each article inspection apparatus as a software update target, and can centrally manage the information related to the software update. In addition, on the user side of the article inspection apparatus, at the time of the additional training of the trained model in use or at the time of the function addition by the newly trained model, the information related to the trained model in use is accurately managed for each apparatus, and it is possible to prevent the management of the trained model from becoming complicated.

According to a sixth embodiment, there is provided a software management method of an inspection unit of an article inspection apparatus including a sensor that outputs a detection signal for inspecting a quality state of an article, and the inspection unit that inspects the quality state of the article by applying a trained model to a predetermined detection signal output by the sensor during a movement of the article, the method including: an update information reception stage of causing the article inspection apparatus to receive software update waiting information related to an addition or update of the trained model from an external server outside the article inspection apparatus; an identification information transmission stage of transmitting identification information of the trained model specified by the software update waiting information received in the update information reception stage to the external server; a model transfer stage of transferring an updated model of the trained model specified by the software update waiting information and identification information after the update to the article inspection apparatus; an installation stage of installing the trained model transferred to the article inspection apparatus in the inspection unit of the article inspection apparatus for the addition or update; and an identification information storage stage of additionally storing the identification information of the trained model added or updated by being installed in the inspection unit in the installation stage, in the inspection unit of the article inspection apparatus.

With this configuration, in a case where the trained model is to be added to or updated in the inspection unit of the article inspection apparatus, the identification information of the trained model is stored in the inspection unit. Therefore, in a case where the software update waiting information is received, it is possible to easily determine whether or not the trained model specified by the received information is in use or is a software update target by the identification information, and in a case where the trained model is the software update target, the identification information of the trained model is accurately transmitted to the external server, and the trained model which is added or updated can be acquired by the trained model acquisition means by downloading or the like. In addition, in a case where the acquired trained model is installed in the inspection unit for the addition or update, the identification information of the trained model is additionally stored in the model information storage means by the identification information management unit, so that information related to the trained model in use on the user side who owns the article inspection apparatus is accurately managed for each apparatus at the time of additional training of the trained model in use or at the time of function addition by the newly trained model, and it is possible to prevent the management of the trained model from becoming complicated.

In addition, the identification information of the added or updated trained model is additionally stored in the inspection unit of the article inspection apparatus. Therefore, for the trained model in which update (for example, transfer learning) is performed in which only some layers of the multi-layer neural network are retrained, added, or deleted according to the addition or change of the inspection target variety, parameters of the other layers maintained in a state before the update can be accurately grasped based on the identification information of the trained model before the update, and an update history and a status of each article inspection apparatus can be accurately grasped on the external server side, and additional training or the like can be accurately executed.

According to a seventh embodiment, in the identification information transmission stage, in a case where the identification information of the trained model designated by the software update waiting information matches any of the identification information of the trained model stored in the inspection unit in the identification information storage stage, the identification information of the matching trained model is transmitted to the external server together with an individual identification code of the article inspection apparatus.

In this manner, on the manufacturer side having the external server, it is possible to accurately grasp a software update state related to the addition or update of the trained model in use in each article inspection apparatus as a software update target, and to centrally manage information related to the software update.

According to an eighth embodiment, in the identification information transmission stage, the identification information of the trained model designated by the software update waiting information is acquired as at least one model identification code and displayed on a screen, and the identification information of the trained model to be transmitted to the external server is selected from the identification code being displayed on the screen according to a selection operation input.

In this case, a user of each article inspection apparatus can easily set whether or not a software update is necessary and an update time.

### Advantage of the Invention

According to the present invention, it is possible to provide an article inspection apparatus and an article inspection system capable of preventing management of a trained model from becoming complicated.

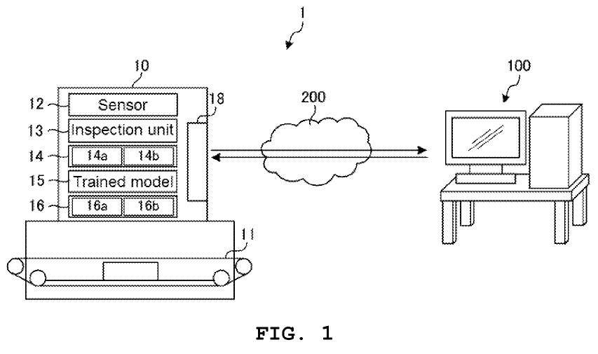

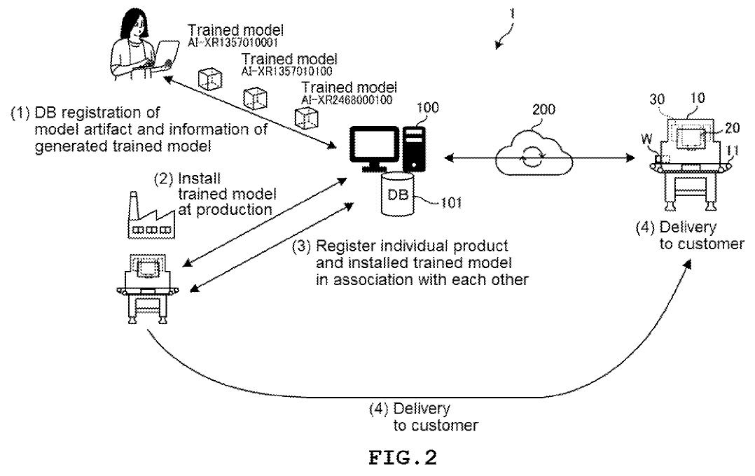

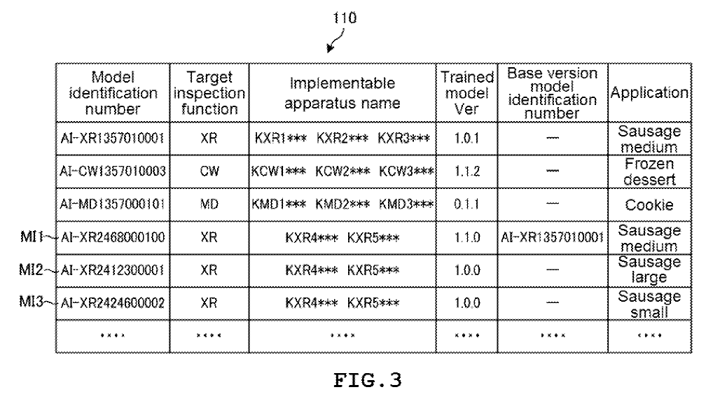

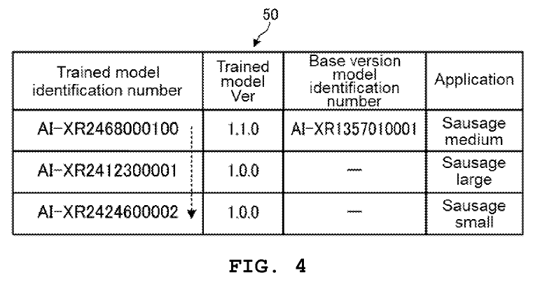

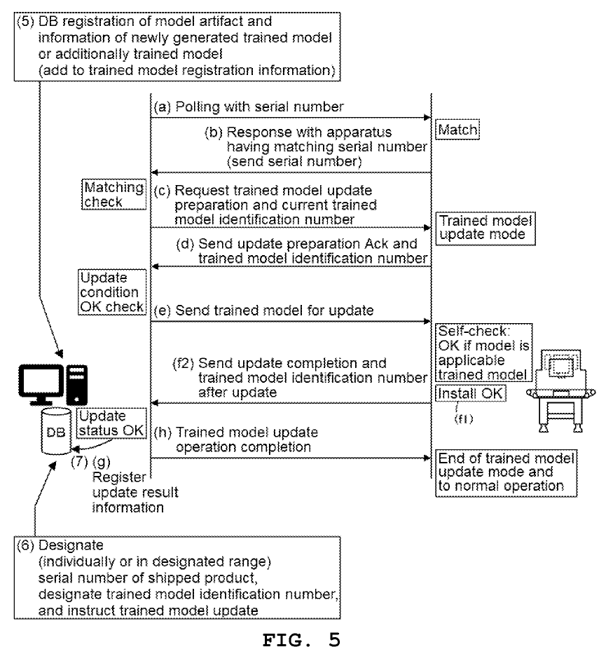

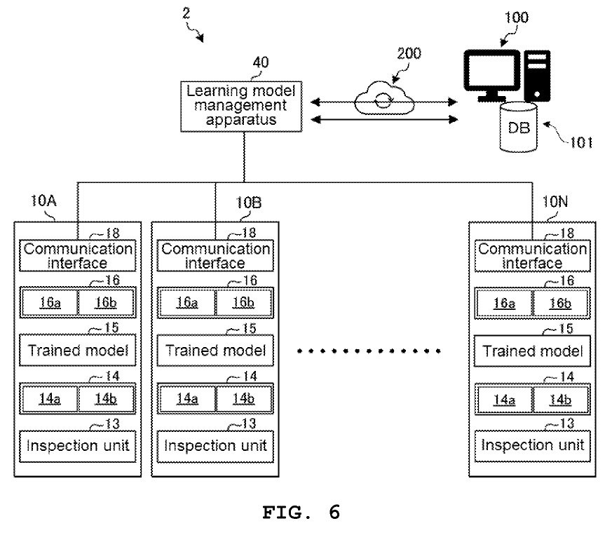

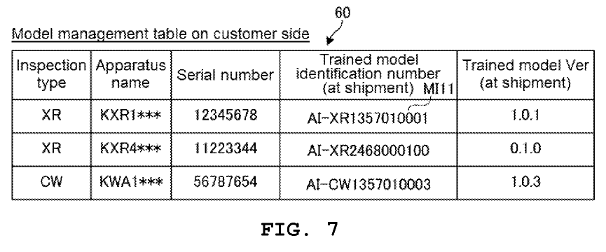

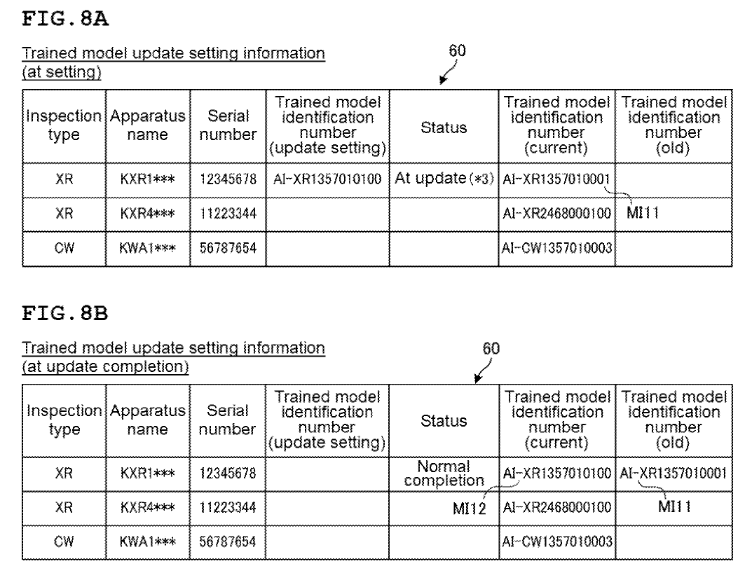

### BRIEF DESCRIPTION OF THE DRAWINGS

[FIG. 1] FIG. 1 is a schematic configuration diagram of a minimum configuration article inspection system including an article inspection apparatus according to an embodiment of the present invention.

[FIG. 2] FIG. 2 is an explanatory diagram of handling of information from an initial installation stage of a trained model before delivery to a customer to a stage at which a software update is available via a communication network after the delivery to the customer in the article inspection apparatus according to the embodiment of the present invention.

[FIG. 3] FIG. 3 is an explanatory diagram of a learning model management table on a manufacturer side registered in an external server for performing a software update related to an addition and update of the trained model in the article inspection apparatus according to the embodiment of the present invention.

[FIG. 4] FIG. 4 is an explanatory diagram of a learning model management table on an apparatus side stored in model information storage means in the article inspection apparatus according to the embodiment of the present invention.

[FIG. 5] FIG. 5 is a sequence diagram illustrating a processing procedure in a case where the software update related to the addition and update of the trained model is performed between the article inspection apparatus according to the embodiment of the present invention and the external server.

[FIG. 6] FIG. 6 is a schematic configuration diagram of an article inspection system according to another embodiment of the present invention.

[FIG. 7] FIG. 7 is an explanatory diagram of a learning model management table on a customer side in which installation information of an article inspection apparatus at a time of shipment in the article inspection system according to the other embodiment of the present invention is stored in a management computer.

[FIGS. 8A and 8B] FIG. 8A is an explanatory diagram of a learning model management table illustrating update setting information in a case of setting an update of a trained model in the article inspection system according to the other embodiment of the present invention, and FIG. 8B is an explanatory diagram of a learning model management table illustrating update setting information at a time of update completion of the trained model in the article inspection system according to the other embodiment of the present invention.

### BEST MODE FOR CARRYING OUT THE INVENTION

Hereinafter, embodiments according to the present invention will be described with reference to the drawings.

### One Embodiment

FIGS. 1 to 4 illustrate an article inspection apparatus and an article inspection system including the article inspection apparatus according to the embodiment of the present invention, and FIG. 5 illustrates a schematic processing procedure of a software management method of the article inspection apparatus according to the embodiment of the present invention.

### First, a configuration thereof will be described.

As illustrated in FIG. 1, an article inspection system 1 of the present embodiment includes an article inspection apparatus 10 and an external server 100 capable of information communication via an information communication network 200 of a predetermined communication method.

The article inspection apparatus 10 includes a conveyor 11 that transports an article W which is an inspection target article, a sensor 12 that outputs an inspection image or a sensor signal including a feature amount corresponding to a quality state of the article W during transport, and an inspection unit 13 that inspects the quality state of the article W based on the feature amount by applying a trained model 15 to the output of the sensor 12.

The article inspection apparatus 10 detects X-rays transmitted through the article W transported by the conveyor 11 by using the sensor 12 while irradiating the article W with the X-rays by using, for example, the inspection unit 13, outputs a brightness signal for each predetermined pixel region, acquires an inspection image corresponding to a distribution of an X-ray transmission amount, applies the trained model 15 to the inspection image, and extracts a predetermined feature amount necessary for a quality determination process on the article W, thereby performing an article inspection. The quality state mentioned herein is, for example, the presence or absence of a mixed foreign matter, the presence or absence of a missing product, the presence or absence of a defect in shape, size, storage state, or the like of contents, a distribution of a density, a thickness, a volume, or a mass, and the like, which represent appropriateness and the like of a quality or a physical quantity required for the article W as a product.

The article inspection function performed by the inspection unit 13 of the article inspection apparatus 10 is not limited to the X-ray inspection function (XR), and may be various functions of a camera inspection function of inspecting an exterior or transmission camera image by using near infrared rays (NIR) as an inspection image, a foreign metal detection function (MD) of detecting a foreign metal based on a change in an alternating current or direct current magnetic field, a weight check function (CW) of measuring a mass by using a load cell or an electromagnetic balance scale, and the like.

The article inspection apparatus 10 has an information management storage unit 14 and an information acquisition unit 16 to execute a software updating process of the inspection unit 13 including the trained model 15, and has a communication interface 18 for data-communicating with the external server 100.

The information management storage unit 14, the information acquisition unit 16, and the communication interface 18 constitute a part of a control unit 30 that controls an inspection process and a determination process executed by the inspection unit 13 according to the output of the sensor 12, and have a plurality of control programs and a work memory region corresponding to a plurality of functions to exhibit a function of controlling the software updating process related to an addition or update of the trained model 15.

For the inspection control by the inspection unit 13 and the software updating process described above, the control unit 30 is configured to include, for example, a processor having a CPU, a ROM, a RAM, and an I/O interface (not illustrated), a control program for exhibiting the functions of the image processing unit and the inspection determination unit to which the trained model 15 is applied and the plurality of functions for the software updating process, an auxiliary storage device that stores network structure information, variables, and the like in cooperation with the ROM to be readable, a timer circuit, and the like, and the CPU executes a predetermined arithmetic process while exchanging data with the RAM or the like in accordance with the control program stored in the ROM or the like and executes the control program.

The information management storage unit 14 has model information storage means 14a for storing the trained model 15 and identification information thereof, and has self-apparatus information storage means 14b for storing an individual identification code of the article inspection apparatus 10, that is, a serial number of the article inspection apparatus 10, or further a model specification code.

The information acquisition unit 16 can receive software update waiting information related to an addition or update of the trained model 15 from the external server 100 via the communication interface 18 as information for polling with identification information of the trained model 15 and/or the article inspection apparatus 10, for example, the serial number, which is used to specify a software update target.

The information acquisition unit 16 further includes trained model acquisition means 16a for, in a case where the article inspection apparatus 10 is a target to which the software update is to be applied, which is specified by the serial number received by polling, transmitting to the external server 100 with the serial number indicating that the article inspection apparatus 10 is an apparatus that matches the serial number by the polling as a response, and acquiring the trained model 15 which is added or updated and the serial number thereof by downloading.

Here, a case where the article inspection apparatus 10 is an application target of the addition or update of the trained model 15, which is specified by the received information, for example, a case where the serial number of the trained model 15 as an update target is stored in the information management storage unit 14 or a case where the serial number or the model specification code of the article inspection apparatus 10 specified as an application target of the additional trained model 15 (hereinafter, unless otherwise specified, the term "trained model 15" includes both the existing trained model 15 and the trained model 15 to be added) that can be installed in addition to the existing trained model 15 is stored in the information management storage unit 14.

More specifically, the information management storage unit 14 has a function of an identification information management unit that additionally stores the serial number of the installed trained model 15 in a predetermined storage region of the model information storage means 14a in a case where the trained model 15 is installed in the inspection unit 13 for the addition or update.

In addition, the information acquisition unit 16 has trained model acquisition means 16a for transmitting, in a case where the serial number of the trained model 15 designated by polling matches any of serial numbers of the trained models 15 stored in the model information storage means 14a of the information management storage unit 14, a serial number of the matching trained model 15 to the external server 100, together with the serial number of the article inspection apparatus 10.

Further, the information acquisition unit 16 has selection control means 16b for acquiring the serial number of the trained model 15 designated by polling as at least one model identification code, displaying the serial number on a screen of a touch panel type display operation unit 20, and selecting identification information of the trained model 15 to be transmitted to the external server 100 from the identification code during the screen display according to a selection operation input.

On the other hand, in the article inspection system 1 of the present embodiment, the external server 100 that is provided to be connectable to the article inspection apparatus 10 through the network is a file server that can perform software management such as sharing or migration of files or the like related to the addition and update of the trained model 15 between the same types of apparatuses. The external server 100 as the file server has a database 101 that manages the serial number of the trained model 15 acquired by the article inspection apparatus 10 at least in association with the individual identification code of the article inspection apparatus 10.

Next, a method of software management of the article inspection apparatus 10 by the external server 100 will be described.

First, in a case where the trained model 15 applied to the article inspection apparatus 10 is generated on the manufacturer side, a model artifact of the trained model 15 and information (which may include a data set for verification in addition to the identification information) related thereto are registered in the database 101 of the external server 100 (see DB registration work (1) in FIG. 2).

Then, in a case where each article inspection apparatus 10 is manufactured, the trained model 15 to be applied and relevant information are extracted from information registered in the database 101 of the external server 100 and are installed in the article inspection apparatus 10 (see model installation work (2) in FIG. 2).

Further, a serial number (machine manufacturing number), which is individual identification code of each article inspection apparatus 10, and a serial number (model identification information) of the trained model 15 installed on the article inspection apparatus 10 are associated with each other, and are registered in the database 101 of the external server 100 (see linking and registration work (3) for individual product and installed model in FIG. 2).

In a case where the article inspection apparatus 10 manufactured in this manner is delivered to a customer as a product and the article inspection apparatus 10 is installed to be operable, the article inspection apparatus 10 can be network-connected to the external server 100 which is capable of data communication via the predetermined wide-area communication network 200. Meanwhile, a communication form in which a management computer in a company of the customer who manages the article inspection apparatus 10 is interposed in front of the wide-area communication network 200 may be used. The predetermined communication network 200 is a network that can perform polling and data communication from the external server 100 side to the article inspection apparatus 10 side (each article inspection apparatus 10 or the management computer in the company of the customer managing the article inspection apparatus 10) and can interpose a so-called field network on the article inspection apparatus 10 side.

A model management table 110 on the manufacturer side as illustrated in FIG. 3 is stored and preserved in the database 101 of the external server 100. In the model management table 110 on the manufacturer side, in a case where a newly trained model is generated, as illustrated in FIG. 3, a model identification number of the trained model (for example, MI1, MI2, and MI3 in FIG. 3), a target inspection function, a model name of the article inspection apparatus 10 to perform the target inspection function in which the trained model can be implemented, version information (referred to as "Ver" in FIG. 3) of the trained model, an identification number of the base version model, and an application are registered (see database registration work (1) in FIG. 2) each time.

On the other hand, the information management storage unit 14 of each article inspection apparatus 10 delivered to the customer stores and preserves a model management table 50 on the apparatus side as illustrated in FIG. 4. As illustrated in FIG. 4, in the model management table 50 on the apparatus side, the identification number of the trained model, the version information (referred to as “Ver” in FIG. 4) of the trained model, the identification number of the base version model, and the application are registered, and these contents match a part of the database information of the model management table 110 on the manufacturer side (for example, MI1, MI2, and MI3 in FIG. 3).

In a case where the management computer in the company at the customer side is connected to each article inspection apparatus 10 and is interposed in front of the predetermined communication network 200, the model management table 50 on the apparatus side or a plurality of model management tables 50 including the model management table 50 may be stored and preserved in the management computer from the external server 100 side in association with an apparatus serial number (machine manufacturing number) of each article inspection apparatus 10. In that case, in a field network in which the management computer in the company of the customer is disposed, a plurality of the article inspection apparatuses 10 can be centrally managed by the management computer.

In this manner, for the trained model 15 used in the article inspection apparatus 10, a software update for updating the trained model by additional training according to the change of the inspection target article or the like may be requested, or the trained model may be updated by the manufacturer side for such a customer request or improvement of the inspection accuracy.

In a case of updating such software, as illustrated in the sequence diagram of FIG. 5, first, information for polling with a serial number indicating that the software update is waiting for an addition or update of the trained model 15 is received from the external server 100 by the article inspection apparatus 10 (update information reception stage; see procedure (a) in FIG. 5).

Next, in a case where a serial number of the existing trained model 15 as an update target, which is specified by the software update waiting information related to the addition or update of the trained model having the specific serial number received in the update information reception stage, is stored in the information management storage unit 14, or in a case where the serial number or the model specification code of the article inspection apparatus 10 specified as an application target of the additional trained model 15 that can be installed in addition to the existing trained model 15 is stored in the information management storage unit 14, information is transmitted to the external server 100 to indicate that the article inspection apparatus 10 has the serial number that matches the serial number of polling (identification information transmission stage; see procedure (b) in FIG. 5).

In a case of checking the update target matching by the serial number from the article inspection apparatus 10 side that responds that the article inspection apparatus 10 is an apparatus having the serial number matching the serial number of polling, the external server 100 side notifies preparation of the model artifact of the trained model 15 related to the addition or update, for example, by requesting the serial number of the existing trained model 15 in the article inspection apparatus 10 as an update target (see procedure (c) in FIG. 5).

On the other hand, on the corresponding article inspection apparatus 10 side, after the article inspection apparatus 10 is transitioned to a learning model update mode, an acknowledgement response (hereinafter “Ack response”) indicating that the notification of the preparation of the model artifact of the trained model 15 has been recognized is transmitted, and the serial number of the existing trained model 15 or the serial number of the article inspection apparatus 10 as a trained model addition target is transmitted to the external server 100 side (see procedure (d) in FIG. 5).

Next, on the external server 100 side, based on the serial number received together with the Ack response, the model artifact of the trained model 15 related to the addition or update is prepared, and a transfer process (a downloading process) of sending the trained model 15 and the identification information thereof to the article inspection apparatus 10 as a software update target is executed. That is, a process in a model transfer stage in which the updated model of the trained model 15 specified by the software update waiting information and the identification information after the update are transferred to the article inspection apparatus 10 as a software update target is executed (see procedure (e) in FIG. 5).

In a case where the sending of the trained model 15 related to the addition or update to the article inspection apparatus 10 as a software update target is completed and the article inspection apparatus 10 as the update target checks the delivery, the trained model 15 related to the addition or update can be installed in the article inspection apparatus 10 as the update target. Therefore, a process of installing the trained model 15 transferred to the article inspection apparatus 10 in the inspection unit 13 of the article inspection apparatus 10 for the addition or update is executed (installation stage (f1)).

Then, in a case where the installation is normally completed, the identification number of the updated trained model is transmitted to the external server 100 side to notify the update completion from the article inspection apparatus 10 side as the update target (see procedure (f2) in FIG. 5).

In this case, further, the article inspection apparatus 10 for which the current software update is completed additionally stores the serial number of the trained model 15 that has been installed and added or updated in the inspection unit 13 in the installation stage in the model information storage means 14a of the information management storage unit 14 associated with the inspection unit 13 of the article inspection apparatus 10 (identification information storage stage).

In addition, on the external server 100 side that has received the identification number of the trained model after the update, it is recognized that the update status is OK, and the serial number, which is model identification information of the trained model 15 after the current software update that has been added or updated, and the apparatus serial number (machine manufacturing number) of the article inspection apparatus 10 that has been updated are associated with each other and are registered in the database 101 (see procedure (g) in FIG. 5).

Then, after the registration is completed, the external server 100 side notifies the article inspection apparatus 10 for which the current software update is completed that the update operation of the trained model 15 is completed. As a result, the article inspection apparatus 10 side can return from a trained model update mode to a normal operation mode.

When the software update process is executed by using this series of communication sequences, the manufacturer side of the article inspection apparatus 10 and the trained model 15 registers a model artifact of a newly generated trained model or an additionally trained model that can be installed in the article inspection apparatus 10 after shipment and identification information thereof in the model management table 110 on the manufacturer side in the database 101, and when trained model registration information is added (see trained model registration information addition work (5) in FIG. 5), the polling of the procedure (a) in FIG. 5 is executed by simultaneous transmission or round-robin transmission.

In addition, by individually designating the serial number indicating the machine manufacturing number of the shipped article inspection apparatus 10 or designating the serial number in a designated range, and designating the identification number of the trained model, the software update target related to the addition or update of the trained model 15 can be specified (see trained model update instruction (6) in FIG. 5).

Further, in a case where it is recognized that the update status is OK on the external server 100 side that has received the identification number of the updated trained model, the information registration of the update result is executed as in the procedure (g) in FIG. 5 described above (see update information registration work of update result (7) in FIG. 5).

### Next, actions will be described.

In the article inspection system 1 of the present embodiment configured as described above, the trained model 15 in use and the identification information thereof are stored in the model information storage means 14a of the information management storage unit 14, and in a case where the software update waiting information is received by polling of the serial number, whether or not the trained model 15 specified by the received information is in use or is a software update target is easily determined by the designated identification information. In addition, in a case where the article inspection apparatus 10 is the software update target, the identification information of the trained model 15 can be transmitted to the external server 100, and the trained model 15 which is added or updated can be acquired by downloading or the like by the trained model acquisition means 16a of the information acquisition unit 16. Then, in a case where the acquired trained model 15 is installed in the inspection unit 13 for the addition or update, the identification information of the trained model 15 is additionally stored in the storage region of the model information storage means 14a by the information management storage unit 14 as the identification information management unit.

Therefore, at the time of additional training of the trained model 15 in use or at the time of adding a function by a newly added trained model 15, the information related to the trained model 15 in use on a user side who owns the article inspection apparatus 10 is accurately managed for each apparatus, and it is possible to prevent the management of the trained model 15 from becoming complicated.

In addition, in the present embodiment, in a case where the identification information of the trained model 15 designated by the software update waiting information (polling) matches any of the identification information of the trained model 15 stored in the model information storage means 14a of the information management storage unit 14, the trained model acquisition means 16a of the information acquisition unit 16 transmits identification information of the matching trained model 15 to the external server 100, together with an individual identification code of the article inspection apparatus 10. Therefore, on the manufacturer side having the external server 100, it is possible to accurately grasp a software update state related to the addition or update of the trained model 15 in use in each article inspection apparatus 10 as a software update target based on the individual identification code of each apparatus, and to centrally manage information related to the software update.

Further, in the present embodiment, in a case where the information acquisition unit 16 acquires the identification information of the trained model 15 designated by the software update waiting information as at least one model identification code by the trained model acquisition means 16a, the acquired information can be displayed on a screen of the display operation unit 20 and the identification information of the trained model 15 to be transmitted to the external server 100 can be selected from the identification code being displayed on the screen, according to a selection operation input, for example, by the selection control means 16b in a list display. Therefore, the user of each article inspection apparatus 10 can easily set whether or not software update is necessary and the update time.

In the article inspection system 1 of the present embodiment, the external server 100 as a file server that is provided to be connectable to the article inspection apparatus 10 through the network has the database 101 for managing the identification information of the trained model 15 acquired by the article inspection apparatus 10 at least in association with the article inspection apparatus 10. Therefore, since the identification information of the trained model 15 acquired by each article inspection apparatus 10 is managed in the database at least in association with the article inspection apparatus 10, the manufacturer side having the external server 100 can accurately grasp a software update state related to the addition or update of the trained model 15 in use in each article inspection apparatus 10 as the software update target, and can centrally manage the information related to the software update.

In addition, on the user side of the article inspection apparatus 10, at the time of the additional training of the trained model 15 in use or at the time of the function addition by the newly trained model, the information related to the trained model 15 in use is accurately managed for each apparatus, and it is possible to prevent the management of the trained model 15 from becoming complicated.

Further, the software management method of the article inspection apparatus according to the present embodiment includes the update information reception stage (a) in which the software update waiting information is received from the external server 100 by the article inspection apparatus 10 by polling with the serial number, the identification information transmission stage (b) in which the identification information of the trained model 15 received in the update information reception stage (a) is transmitted to the external server 100, the model transfer stage (e) in which the updated model of the trained model 15 and the identification information after the update are transferred to the article inspection apparatus 10, the installation stage (f) in which the trained model 15 transferred to the article inspection apparatus 10 is installed in the inspection unit 13 of the article inspection apparatus for the addition or update, and the identification information storage stage (g) in which the identification information of the trained model 15 added or updated by being installed in the inspection unit 13 in the installation stage is additionally stored in the inspection unit 13 of the article inspection apparatus 10.

Therefore, in the trained model management method according to the present embodiment, in a case where the trained model 15 is to be added to or updated in the inspection unit 13 of the article inspection apparatus 10, it is possible to easily determine whether or not the trained model 15 specified by the received information of the software update waiting information is in use or is a software update target by the identification information, and in a case where the trained model 15 is the software update target, it is possible to accurately transmit the identification information of the trained model 15 to the external server 100 and to acquire the trained model 15 which is added or updated by the trained model acquisition means 16a of the information acquisition unit 16 by downloading or the like. In addition, in a case where the acquired trained model 15 is installed in the inspection unit 13 for the addition or update, the identification information of the trained model 15 is additionally stored in the model information storage means 14a by the information management storage unit 14 which is the identification information management unit, so that information related to the trained model 15 in use on the user side who owns the article inspection apparatus 10 is accurately managed for each apparatus at the time of additional training of the trained model 15 in use or at the time of function addition by the newly trained model 15, and it is possible to prevent the management of the trained model 15 from becoming complicated.

In addition, in the trained model management method of the present embodiment, the identification information of the added or updated trained model 15 is additionally stored in the inspection unit 13 of the article inspection apparatus 10. Therefore, for the trained model 15 in which update (for example, transfer learning) is performed in which only some layers of the multi-layer neural network are retrained, added, or deleted according to the addition or change of the inspection target variety, parameters of the other layers maintained in a state before the update can be accurately grasped based on the identification information of the trained model 15 before the update, and an update history and a status of each article inspection apparatus 10 can be accurately grasped on the external server 100 side, and additional training or the like can be accurately executed.

In addition, in the identification information transmission stage of the present embodiment, in a case where the identification information of the trained model 15 designated by the software update waiting information matches any of the identification information of the trained model 15 stored in the information management storage unit 14 in the identification information storage stage, the identification information of the matching trained model 15 is transmitted to the external server 100 together with the individual identification code of the article inspection apparatus 10. Therefore, the manufacturer side having the external server 100 can accurately grasp the software update state related to the addition or update of the trained model 15 in use in each article inspection apparatus 10 as a software update target, and can centrally manage the information related to the software update.

In the identification information transmission stage of the present embodiment, the identification information of the trained model 15 designated by the software update waiting information is further acquired as at least one model identification code and displayed on the screen of the display operation unit 20, and the identification information of the trained model 15 to be transmitted to the external server 100 is selected from the identification code during the screen display according to the selection operation input. Therefore, the user of each article inspection apparatus 10 can easily set whether or not software update is necessary and the update time.

As described above, according to the present embodiment, it is possible to provide the article inspection apparatus 10 and the article inspection system 1 capable of preventing the management of the trained model 15 from becoming complicated.

### Other Embodiments

FIGS. 6 to 8B illustrate an article inspection apparatus and an article inspection system including an article inspection apparatus according to another embodiment of the present invention.

Since the present embodiment has the common configuration as the embodiment described above, the same reference numerals as the corresponding components of the embodiment described above will be used for the common components, and the repeated description thereof will be omitted.

An article inspection system 2 according to the present embodiment is provided with a plurality of article inspection apparatuses 10A to 10N (N is an integer of 3 or more) and a learning model management apparatus 40 configured with a management computer connected to the plurality of article inspection apparatuses 10A to 10N to be capable of data communication, in a field network in customer premises, and has a system configuration in which the learning model management apparatus 40 is interposed in front of the wide-area communication network 200.

In addition, a plurality of model management tables 50 are transmitted from the external server 100 side to the learning model management apparatus 40, and are stored and preserved in association with apparatus serial numbers (machine manufacturing numbers) of the respective article inspection apparatuses 10A to 10N. In the field network, the management computer functioning as the learning model management apparatus 40 can centrally manage a plurality of the article inspection apparatuses 10A to 10N.

Each of the article inspection apparatuses 10A to 10N may be an apparatus performing a different type of inspection function from the article inspection apparatus 10 of one embodiment, or may be the same apparatus as the article inspection apparatus 10 of one embodiment. In the information management storage unit 14 of each of the article inspection apparatuses 10A to 10N, a model management table on the apparatus side similar to the model management table 50 on the apparatus side is stored and preserved as illustrated in FIG. 4 in one embodiment according to the inspection function of each apparatus, a model type and a version of the trained model 15, and the like.

The learning model management apparatus 40 stores and preserves a model management table 60 on the customer side as illustrated in FIG. 7. As illustrated in FIG. 7, in the model management table 60 on the customer side, a model group indicating types of the inspection function of the plurality of connected article inspection apparatuses 10A to 10N, an apparatus name, a serial number for each apparatus, an identification number of a trained model at a time of shipment of the apparatus, and version information (referred to as “Ver” in FIG. 7) of the trained model at the time of shipment are registered, and the contents thereof match a part of database information of the model management table 110 on the external server manufacturer side.

In a case where a software update is required for any of the trained models 15 used in the respective article inspection apparatuses 10A to 10N, polling is performed from the learning model management apparatus 40 as a primary computer to the respective article inspection apparatuses 10A to 10N in a predetermined order or in parallel in serial numbers of the respective trained models 15 (update information reception stage) with respect to polling from the external server 100, and for example, in any of the article inspection apparatuses 10A to 10N, in a case where the serial number of the existing trained model 15 as an update target, which is specified by software update waiting information, is stored in the information management storage unit 14, the serial number is transmitted as a response from any of the article inspection apparatuses 10A to 10N having the serial number that matches the serial number of the polling, via the learning model management apparatus 40 to the external server 100 (identification information transmission stage).

In the external server 100 side, in a case where the matching of the update target is checked by the serial number from any of the article inspection apparatuses 10A to 10N that respond that the apparatus is an apparatus having the serial number that matches the serial number of polling, a notification of preparation of the model artifact of the trained model 15 related to the addition or update is provided by, for example, requesting the serial number of the existing trained model 15 from any of the article inspection apparatuses 10A to 10N as an update target (see procedure (c) in FIG. 5).

On the other hand, in any of the corresponding article inspection apparatuses 10A to 10N, after the apparatus is transitioned to a learning model update mode, an Ack response indicating that the notification of the preparation of the model artifact of the trained model 15 has been recognized is transmitted, and the serial number of the existing trained model 15 or the serial number of the apparatus as a trained model addition target is transmitted from the learning model management apparatus 40 to the external server 100 side (see procedure (d) in FIG. 5).

Next, on the external server 100 side, based on the serial number received together with the Ack response, the model artifact of the trained model 15 related to the addition or update is prepared, and a transfer process (a downloading process) of sending the trained model 15 and the identification information thereof to any of the article inspection apparatuses 10A to 10N that are the software update targets is executed, that is, a process in a model transfer stage of transferring the updated model of the trained model 15 specified by the software update waiting information and the identification information after the update thereof to any of the article inspection apparatuses 10A to 10N that are the software update targets is executed (see procedure (e) in FIG. 5).

In this case, in a case where the identification numbers of the trained models 15 related to the addition or update are common to the plurality of article inspection apparatuses 10A to 10N, it is also conceivable to cause the learning model management apparatus 40 to manage the update process instead of each update target among the article inspection apparatuses 10A to 10N.

In a case where the sending of the trained model 15 related to the addition or update of any of the article inspection apparatuses 10A to 10N as the software update target is completed and the article inspection apparatus 10 as the update target checks the delivery, the trained model 15 related to the addition or update can be installed on any of the article inspection apparatuses 10A to 10N as the update target. Therefore, a process of installing the trained model 15 transferred to any of the article inspection apparatuses 10A to 10N in the inspection unit 13 of the software update target device for the addition or update is executed (installation stage, see procedure (f1) in FIG. 5).

Then, in a case where the installation is normally completed (installation OK in FIG. 5), the identification number of the updated trained model is transmitted to the external server 100 side to notify the update target apparatus side of the update completion (see procedure (f2) in FIG. 5).

In this case, in any of the article inspection apparatuses 10A to 10N for which the current software update is completed, the serial number of the trained model 15 added or updated by being installed in the inspection unit 13 in the installation stage is additionally stored in a predetermined storage region of the information management storage unit 14 associated with the inspection unit 13 of the article inspection apparatus (identification information storage stage).

In addition, on the external server 100 side that has received the identification number of the updated trained model, it is recognized that the update status is OK, and the serial number, which is model identification information of the trained model 15 after the current software update that has been added or updated, and the apparatus serial numbers (machine manufacturing numbers) of the article inspection apparatuses 10A to 10N that have been updated are associated with each other and are registered in the database 101 (see procedure (g) in FIG. 5).

Then, after the registration is completed, a notification of the completion of the update operation of the trained model 15 is sent from the external server 100 side to any of the article inspection apparatuses 10A to 10N for which the current software update is completed. As a result, the article inspection apparatus 10 side can return from a trained model update mode to a normal operation mode.

In a case where the software update process is executed by using such a series of communication sequences, the manufacturer side of the article inspection apparatuses 10A to 10N and the same model type or different model type of the trained model 15 installed on each of the article inspection apparatuses 10A to 10N registers the model artifact and the identification information of the newly generated trained model or the additionally trained model that can be installed on each of the article inspection apparatuses 10A to 10N after shipment in the model management table 110 on the manufacturer side in the database 101, and when the trained model registration information is added (see trained model registration information addition work (5) in FIG. 5), the polling process of the procedure (a) in FIG. 5 is executed by simultaneous transmission or round-robin transmission.

In addition, by designating the serial numbers of the shipped article inspection apparatuses 10A to 10N individually or in a designated range and designating the identification numbers of the trained models, the software update target related to the addition or update of each trained model 15 can be specified (see the trained model update instruction (6) in FIG. 5).

In the present embodiment, even in a case of the additional training of the trained model 15 in use or the addition of a new function by the trained model 15, information related to the trained model 15 in use on the user side who owns each of the article inspection apparatuses 10A to 10N is accurately managed for each apparatus, and it is possible to prevent the management of the trained model 15 from becoming complicated.

In addition, in a case where the software update related to the addition or update of the trained model 15 used in any of the inspection units 13 of the article inspection apparatuses 10A to 10N is performed, as illustrated in FIGS. 7, 8A, and 8B, in addition to the old learning model identification number (indicated by MI11 in FIGS. 7 and FIGS. 8A and 8B) before the update, the current learning model identification number (indicated by MI12 in FIGS. 8A and 8B) after the update is additionally stored in the model management table 60 on the customer side stored in the learning model management apparatus 40, and further in the model management table 50 on the apparatus side associated with the inspection unit 13 of each of the article inspection apparatuses 10A to 10N. Therefore, for example, for the trained model 15 that has been subjected to the update in which only some layers of the multi-layer neural network are retrained, added, or deleted according to the addition or change of the inspection target variety, parameters of the other layers maintained before the update can be accurately grasped based on the identification information of the trained model before the update, the update history and the status of each of the article inspection apparatuses 10A to 10N can be accurately grasped even on the external server 100 side, and the additional training and the like can be accurately executed.

Therefore, in the present embodiment as well, the same effects as those of the embodiment can be obtained.

As described above, the present invention can provide the article inspection apparatus and the article inspection system capable of preventing the management of the trained model from becoming complicated. The present invention is useful for an article inspection apparatus and an article inspection system that inspect a quality state of an article as an inspection target by applying a trained model to an inspection image or a sensor signal according to the quality state of the article, and a software management method of the article inspection apparatus.

### Description of Reference Numerals and Signs

1, 2: article inspection system

10, 10A to 10N: article inspection apparatus

11: conveyor

12: sensor

13: inspection unit

14: information management storage unit (identification information management unit)

14a: model information storage means

14b: self-apparatus information storage means

15: trained model

16: information acquisition unit

16a: trained model acquisition means

16b: selection control means

18: communication interface

20: display operation unit

30: control unit

40: learning model management apparatus (management computer)

50: model management table on apparatus side

60: model management table on customer side (model management table stored in management computer)

100: external server (file server, external server outside article inspection apparatus)

101: database (DB)

110: model management table on manufacturer side

200: information communication network (communication network)

MI1: model identification number (any of identification information of stored trained model)

MI2, MI3: model identification number (identification information of trained model which is added or updated)

MI11: trained model identification number (any of identification information of stored trained model)

MI12: trained model identification number (identification information of trained model which is added or updated)

What is claimed is:

1. An article inspection apparatus comprising:
a sensor that outputs a detection signal for inspecting a quality state of an article;
an inspection unit that inspects the quality state of the article by applying a trained model to a predetermined detection signal output by the sensor during a movement of the article;
a communication interface for communicating with an external server;
model information storage means for storing identification information of the trained model installed in the article inspection apparatus;
trained model acquisition means for receiving software update waiting information related to an addition or update of the trained model, transmitting the identification information of the trained model specified by the received information to the external server, and acquiring the trained model which is added or updated and the identification information of the trained model, via the communication interface; and
an identification information management unit that, in a case where the trained model acquired by the trained model acquisition means is installed in the inspection unit for the addition or update, additionally stores the identification information of the installed trained model in the model information storage means.

2. The article inspection apparatus according to claim 1,
wherein the trained model acquisition means transmits, in a case where the identification information of the trained model designated by the software update waiting information matches any of the identification information of the trained model stored in the model information storage means, identification information of the matching trained model to the external server together with an individual identification code of the article inspection apparatus.

3. The article inspection apparatus according to claim 1,
wherein the trained model acquisition means includes selection control means for acquiring the identification information of the trained model designated by the software update waiting information as at least one model identification code and displaying the model identification code on a screen, and selecting the identification information of the trained model to be transmitted to the external server, from the identification code being displayed on the screen according to a selection operation input.

4. The article inspection apparatus according to claim 2,
wherein the trained model acquisition means includes selection control means for acquiring the identification information of the trained model designated by the software update waiting information as at least one model identification code and displaying the model identification code on a screen, and selecting the identification information of the trained model to be transmitted to the external server, from the identification code being displayed on the screen according to a selection operation input.

5. An article inspection system comprising:
the article inspection apparatus according to claim 1; and
a file server as the external server that is provided to be connectable to the article inspection apparatus through a network,
wherein the file server has a database for managing the identification information of the trained model acquired by the article inspection apparatus at least in association with the article inspection apparatus.

6. A software management method of an inspection unit of an article inspection apparatus including a sensor that outputs a detection signal for inspecting a quality state of an article, and the inspection unit that inspects the quality state of the article by applying a trained model to a predetermined detection signal output by the sensor during a movement of the article, the method comprising:
an update information reception stage of causing the article inspection apparatus to receive software update waiting information related to an addition or update of the trained model from an external server outside the article inspection apparatus;
an identification information transmission stage of transmitting identification information of the trained model specified by the software update waiting information received in the update information reception stage to the external server;
a model transfer stage of transferring an updated model of the trained model specified by the software update waiting information and identification information after the update to the article inspection apparatus;
an installation stage of installing the trained model transferred to the article inspection apparatus in the inspection unit of the article inspection apparatus for the addition or update; and
an identification information storage stage of additionally storing the identification information of the trained model added or updated by being installed in the inspection unit in the installation stage, in the inspection unit of the article inspection apparatus.

7. The software management method of the article inspection apparatus according to claim 6,
wherein in the identification information transmission stage, in a case where the identification information of the trained model designated by the software update waiting information matches any of the identification information of the trained model stored in the inspection unit in the identification information storage stage, the identification information of the matching trained model is transmitted to the external server together with an individual identification code of the article inspection apparatus.

8. The software management method of an article inspection apparatus according to claim 7,
wherein in the identification information transmission stage, the identification information of the trained model designated by the software update waiting information is acquired as at least one model identification code and displayed on a screen, and the identification information of the trained model to be transmitted to the external server is selected from the identification code being displayed on the screen according to a selection operation input.
